(19) United States
(12) Patent Application Publication
(10) Pub. No.: US 2025/0246655 A1
(43) Pub. Date: Jul. 31, 2025

(54) FUEL CELL SYSTEM INCLUDING A SYSTEM EXHAUST BACKFLOW CONTROL VALVE AND METHODS OF OPERATING THE SAME

(71) Applicant: Bloom Energy Corporation, San Jose, CA (US)

(72) Inventors: Purushothaman JAGANATHAN, Mumbai (IN); Pratik K. MARATHE, Mumbai (IN); Lorenzo PENNA, San Jose, CA (US); Samuel JUDAY, Sunnyvale, CA (US); Shraddesh MALVIYA, Mumbai (IN); Shannon BELL, San Jose, CA (US); Santina G. CARRANZA, San Jose, CA (US); Robert M. HINTZ, San Jose, CA (US); Zuhir SRAS, San Jose, CA (US)

(21) Appl. No.: 19/038,167

(22) Filed: Jan. 27, 2025

Related U.S. Application Data
(60) Provisional application No. 63/626,740, filed on Jan. 30, 2024.

(51) Int. Cl. H01M 8/04746; H01M 8/04007; H01M 8/04082; H01M 8/04111; H01M 8/04302; H01M 8/0438; H01M 8/0662; H01M 8/2484

(52) U.S. Cl. CPC H01M 8/04761; H01M 8/04067; H01M 8/04111; H01M 8/04201; H01M 8/04302; H01M 8/04395; H01M 8/0662; H01M 8/2484

(57) ABSTRACT

A power module includes a stack of fuel cells, an anode tail gas oxidizer (ATO) configured to oxidize an anode exhaust output from the stack, a system air blower configured to provide air to the stack, at least one air conduit which fluidly connects the system air blower to the stack, at least one exhaust conduit which fluidly connects the ATO to an exhaust manifold, and a first valve configured to reduce or prevent backflow of system exhaust from the exhaust manifold to the system air blower when the power module is offline.

### FIELD

Aspects of the present invention relate to fuel cell systems and methods, and more particularly, to fuel cell systems including at least one system exhaust backflow control valve.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels, or hydrogen containing fuels, such as ammonia. There are classes of fuel cells, such as solid oxide regenerative fuel cells, that also allow reversed operation, such that oxidized fuel can be reduced back to unoxidized fuel using electrical energy as an input.

### SUMMARY

According to various embodiments, a power module includes a stack of fuel cells, an anode tail gas oxidizer (ATO) configured to oxidize an anode exhaust output from the stack, a system air blower configured to provide air to the stack, at least one air conduit which fluidly connects the system air blower to the stack, at least one exhaust conduit which fluidly connects the ATO to an exhaust manifold, and a first valve configured to reduce or prevent backflow of system exhaust from the exhaust manifold to the system air blower when the power module is offline.

According to various embodiments, an electrochemical module includes a stack of electrochemical cells located in a hotbox; a system air blower configured to provide air to the stack; at least one air conduit which fluidly connects the system air blower to the stack; first and second exhaust outlet conduits which fluidly connect the hotbox to an exhaust manifold; a first valve located in the first exhaust outlet conduit and configured to selectively prevent backflow of system exhaust from the exhaust manifold into the hotbox; a second valve located in the second exhaust outlet conduit and configured to selectively prevent backflow of system exhaust from the exhaust manifold into the hotbox; and an actuator comprising one motor configured to simultaneously actuate the first and the second valves.

According to various embodiments, a method of operating a power system comprising a plurality of fuel cell power modules comprises operating the plurality of fuel cell power modules to generate power and output a system exhaust to a common exhaust manifold; taking one of the plurality of power modules offline; and actuating at least one valve of the offline fuel cell power module to prevent or reduce system exhaust backflow from the common exhaust manifold to a system air blower of the offline fuel cell power module.

### BRIEF DESCRIPTION OF THE DRAWINGS

The accompanying drawings, which are incorporated herein and constitute part of this specification, illustrate example embodiments of the invention, together with the general description given above and the detailed description given below.

FIG. 1A is a perspective view of a combined heat and power (CHP) system, according to various embodiments of the present disclosure, and FIG. 1B is a schematic view of components of a power module that may be included in the CHP system of FIG. 1A.

FIG. 2A is perspective view of a gate valve that may be included in a power module of FIG. 1B, according to various embodiments of the present disclosure, FIG. 2B is a plan view showing the gate valve of FIG. 2A in a closed position, FIG. 2C is a plan view showing the gate valve of FIG. 2A in an open position, FIG. 2D is an exploded perspective view of the gate valve of FIG. 2A, and FIG. 2E shows an enlarged portion of FIG. 2D.

FIG. 3 is a schematic view of an alternative power module, according to an alternative embodiment of the present disclosure.

FIG. 4 is a schematic view of an alternative power module, according to another alternative embodiment of the present disclosure.

FIG. 5 is a schematic view of an alternative power module, according to another alternative embodiment of the present disclosure.

FIG. 6A shows a portion of the cabinet of the power module of FIG. 5, including the valve actuator and exhaust outlet conduits, according to various embodiments of the present disclosure, FIG. 6B is an enlarged view of the valve actuator and exhaust outlet conduits, FIG. 6C is a perspective view of the valve actuator and exhaust outlet conduits, and FIG. 6D is a bottom view of the valve actuator and exhaust outlet conduits.

FIG. 7 is a schematic view of an alternative power module, according to another alternative embodiment of the present disclosure.

FIG. 8 is a flow diagram illustrating a method of using a power system, according to various embodiments of the present disclosure.

### DETAILED DESCRIPTION

Various examples will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims. It is also understood that the examples shown in the figures are not mutually exclusive. Features shown in one example (e.g., in one figure) may be included in other examples (e.g., in other figures).

Ranges can be expressed herein as from “about” one particular value, and/or to “about” another particular value. When such a range is expressed, examples include from the one particular value and/or to and including the other particular value. In some embodiments, a value of “about X” may include values of +/−1% X. It will be further understood that the endpoints of each of the ranges are significant both in relation to the other endpoint, and independently of the other endpoint.

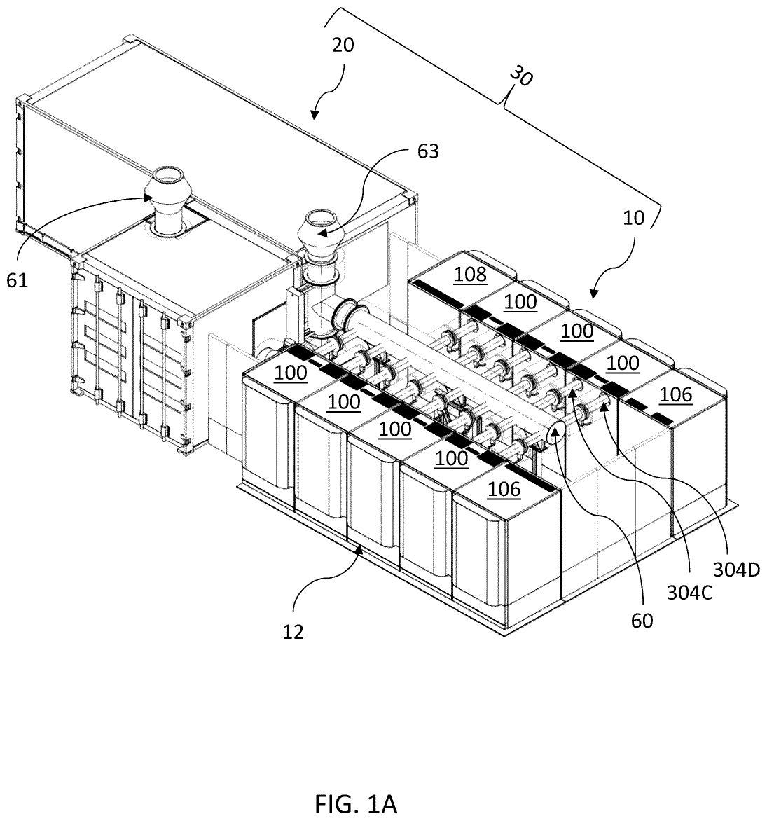

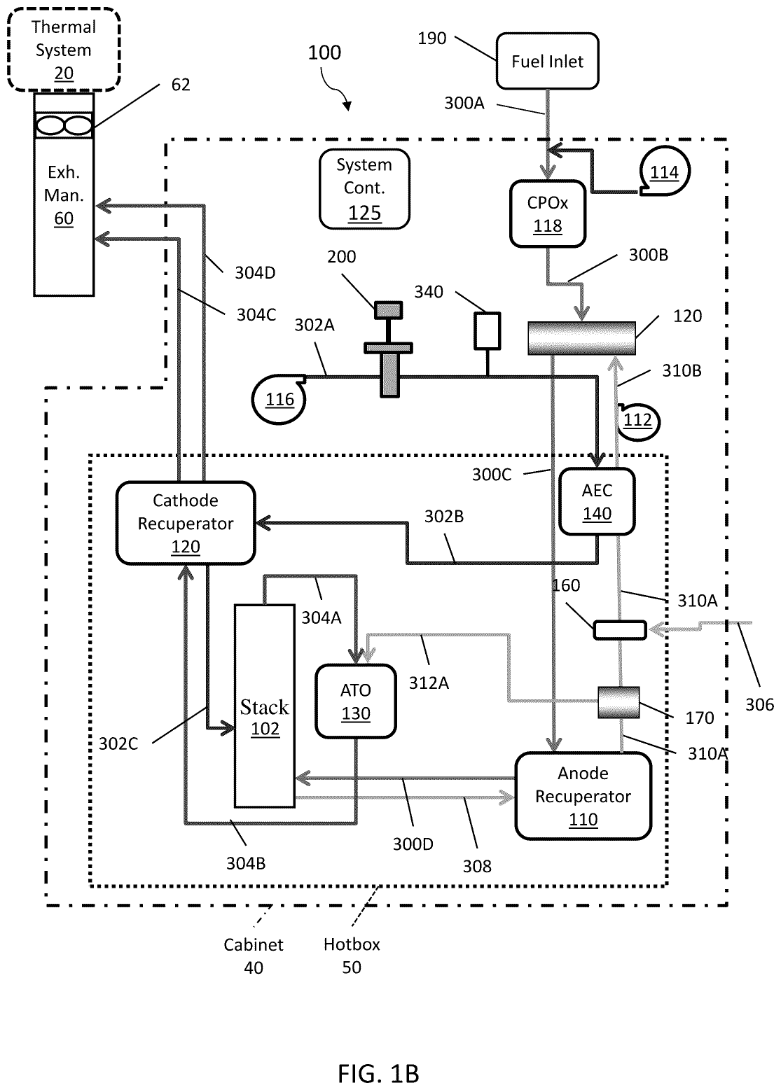

FIG. 1A is a perspective view of an exemplary combined heat and power (CHP) system 30, according to various embodiments of the present disclosure, and FIG. 1B is a schematic view of components of a power module 100 included in the CHP system 30. Referring to FIG. 1A, the CHP system 30 may include a fuel cell system 10 configured to generate electrical power, and a thermal energy system 20 configured to recover and utilize heat generated by the fuel cell system 10.

The fuel cell system 10 may include one or more power modules 100, fuel processing modules 106, and power conditioning (e.g., electrical output) modules 108, which may be located on a base 12. Each of the modules 100, 106, 108 may include its own housing or cabinet that is accessible by a door. The base 12 may also provide a common space for electrical wiring and/or fluid conduits that may connect the power modules 100 with the fuel processing and/or power conditioning modules 106, 108. For example, the power modules 100 may be fluidly connected with the fuel processing modules 106 through fluid conduits (e.g., pipes) provided in the base 12, and the power conditioning module 108 may be electrically connected to the power modules 100 through wires and/or cables provided in the base 12. The base 12 may be formed of concrete and/or metal, depending on installation location and/or installation requirements.

The fuel processing module 106 may include components used for pre-processing a fuel, such as, for example, adsorption beds (e.g., desulfurizer and/or other impurity adsorption beds). The fuel processing module 106 may be configured to process different types of fuels. For example, the fuel processing module 106 may include at least one of a diesel fuel processing module, a natural gas fuel processing module, or an ethanol fuel processing module in the same cabinet or in separate cabinets. A different bed composition tailored for a particular fuel may be provided in each fuel processing module 106. The fuel processing module 106 may process at least one of the following fuels: natural gas provided from a pipeline, compressed natural gas, methane, propane, liquid petroleum gas, gasoline, diesel, home heating oil, kerosene, JP-5, JP-8, aviation fuel, hydrogen, ammonia, ethanol, methanol, syn-gas, biogas, biodiesel and other suitable hydrocarbon or hydrogen containing fuels (e.g., pure hydrogen or ammonia). In some examples, a reformer may be included in the fuel processing module 106.

The power conditioning module 108 may include components for converting DC power generated by a fuel cell stack included in the power module 100 to AC power (e.g., at least one DC/AC converter and optionally DC/DC converters described in U.S. Pat. No. 7,705,490, issued Apr. 27, 2010, the content of which is expressly incorporated herein by reference in its entirety), electrical connectors for AC power output to a power grid, circuits for managing electrical transients, and a system controller (e.g., a computer or dedicated control logic device or circuit). The power conditioning module 108 may be configured to convert DC power from the fuel cell modules to different AC voltages and frequencies. Components for 208 V, 60 Hz; 480 V, 60 Hz; 415 V, 50 Hz and other common voltages and frequencies may be provided. The power conditioning module 108 may be electrically connected with the one or more power modules 100, e.g., via wires provided on, in and/or below the base 12, to provide power to the power modules 100 and receive power generated by the power modules 100.

In some embodiments, the functions of the fuel processing module and the power conditioning module may be combined in a single module, such that the above-described fuel processing and power conditioning components may be located in a single cabinet or housing. While two rows of power modules 100 are shown in FIG. 1, the fuel cell system 10 may include a single row or multiple rows of power modules 100. For example, the fuel cell system 10 may include two or more rows of power modules 100 stacked back to back, end to end, side by side, or on top of one another.

The fuel cell system 10 may include an exhaust manifold 60 or conduit configured to provide system exhaust output from the power modules 100 to the thermal energy system 20. In particular, the exhaust manifold 60 may be fluidly connected to the power modules 100 by exhaust conduits 304C, 304D, as described in detail below. The thermal energy system 20 may be any suitable system capable of extracting and utilizing heat generated by the fuel cell system 10. For example, the thermal energy system 20 may include a steam generator, an absorption chiller, a thermoelectric generator, a hot water heater, a Rankine cycle device, a combination thereof, or the like.

In some embodiments, the thermal energy system 20 may be omitted, and the fuel cell system 10 exhaust may be vented without heat recovery. For example, the fuel cell system exhaust and/or cabinet air may be vented from the vent assemblies directly to the atmosphere or to an exhaust manifold 60 that is not connected to a thermal energy system 20. In various embodiments, the fuel cell system 10 may be located outdoors and system exhaust may be directly vented. Alternatively, the fuel cell system 10 may be located indoors and system exhaust may be provided to an exhaust manifold 60 and vented outdoors or provided to a thermal energy system 20. The thermal energy system 20 may include a vent 61 which vents the system exhaust. The exhaust manifold 60 may include an optional bypass vent 63 in case it is desired to vent the system exhaust from the exhaust manifold 60 prior to providing the system exhaust to the thermal energy system.

Referring to FIG. 1B, each power module 100 may include a module cabinet 40 containing a hotbox 50 and various components located therein or adjacent thereto. The hotbox 50 may contain at least one fuel cell stack 102, such as a solid oxide fuel cell stack, containing alternating fuel cells and interconnects. One solid oxide fuel cell of the stack contains a ceramic electrolyte, such as yttria stabilized zirconia (YSZ), scandia stabilized zirconia (SSZ), scandia and ceria stabilized zirconia or scandia, or yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be arranged over each other in a column. Alternatively, a column may contain only one stack 102. Plural columns may be located in each hot box 50.

The hotbox 50 may also contain an anode recuperator heat exchanger 110, a cathode recuperator heat exchanger 120, an anode tail gas oxidizer (ATO) 130, an anode exhaust cooler 140, an optional splitter 170, and a water injector 160. The power module 100 may also include an anode recycle blower 112, a catalytic partial oxidation (CPOx) blower 114 (e.g., a CPOx air blower), a system air blower 116 (e.g., main air blower), a CPOx reactor 118, and a mixer 120 which may be located in the cabinet 40 outside of the hotbox 50. However, the present disclosure is not limited to any particular location for each of the components with respect to the hotbox 50.

The power module 100 may include an air conduit assembly 302 comprising air conduits 302A, 302B, and 302C that fluidly connect the system air blower 116, the anode exhaust cooler 140, the cathode recuperator 120, and the stack 102. The power module 100 may also include an exhaust conduit assembly 304 comprising exhaust conduits 304A, 304B, 304C, and 304D that fluidly connect the stack 102, the ATO 130, the cathode recuperator 120, and the exhaust manifold 60.

The CPOx reactor 118 may receive a fuel inlet stream from a fuel inlet 190, through fuel conduit 300A. The fuel inlet 190 may be a fuel tank or a utility natural gas line including a valve to control an amount of fuel provided to the CPOx reactor 118. The CPOx blower 114 may provide air to the CPOx reactor 118 during system start-up. The air from the CPOx blower 114 is turned off during system steady-state operation. The fuel and/or air may be provided to the mixer 120 by fuel conduit 300B. Fuel flows from the mixer 120 to the anode recuperator 110 through fuel conduit 300C. The fuel is heated in the anode recuperator 110 by the fuel exhaust (anode exhaust from stack 102) and the fuel then flows from the anode recuperator 110 to the stack 102 through fuel conduit 300D.

The system air blower 116 may be configured to provide an air stream (e.g., air inlet stream) to the anode exhaust cooler 140 through air conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stack 102 through air conduit 302C. The power module 100 may include a pressure sensor 340, such as a piezoresistive pressure sensor, configured to measure air pressure in air conduit 302A.

Anode exhaust (e.g., fuel exhaust) generated in the stack 102 is provided to the anode recuperator 110 through an anode exhaust conduit 308. The anode exhaust may contain unreacted fuel and may also be referred to herein as fuel exhaust. The anode exhaust may be provided from the anode recuperator 110 to the mixer 120 by a recycling conduit 310, which may include a first recycling conduit 310A and a second recycling conduit 310B. In particular, the first recycling conduit 310A may fluidly connect an outlet of the anode recuperator 110 to an inlet of the anode exhaust cooler 140. The second recycling conduit 310B may fluidly connect an outlet of the anode exhaust cooler 140 to an inlet of the mixer 120.

Water flows from a water source, such as a water tank or a water pipe, to the water injector 160 through a water conduit 306. Water treatment processes may be applied to water supplied to water conduit 306 to remove impurities before supplying the water to the power module 100. The water injector 160 may be configured to inject water into anode exhaust flowing through the first recycling conduit 310A. Heat from the anode exhaust (also referred to as a recycled anode exhaust stream) vaporizes the water to generate steam which humidifies the anode exhaust. The humidified anode exhaust is provided to the anode exhaust cooler 140. Heat from the anode exhaust provided to the anode exhaust cooler 140 may be transferred to the air inlet stream provided from the system air blower 116 to the cathode recuperator 120. The cooled humidified anode exhaust may then be provided from the anode exhaust cooler 140 to the mixer 120 via the second recycling conduit 310B. The anode recycle blower 112 may be configured to move the anode exhaust though the second recycling conduit 310B.

The mixer 120 is configured to mix the humidified anode exhaust with fresh fuel (i.e., fuel inlet stream). This humidified fuel mixture may then be heated in the anode recuperator 110 by the anode exhaust, before being provided to the stack 102. The power module 100 may also include one or more fuel reforming catalysts located inside and/or downstream of the anode recuperator 110. The reforming catalyst(s) reform the humidified fuel mixture before it is provided to the stack 102.

The splitter 170 may be operatively connected to the first recycling conduit 310A and may be configured to divert a portion of the anode exhaust to the ATO 130 via an ATO conduit 312A. The ATO conduit 312A may be fluidly connected directly to the ATO 130 or indirectly to the ATO 130 via the cathode exhaust conduit 304A.

Cathode exhaust (e.g., air exhaust) generated in the stack 102 is provided to the ATO 130 by cathode exhaust conduit 304A. The cathode exhaust may be mixed with a portion of the anode exhaust before or after being provided to the ATO 130. The mixture of the anode exhaust and the cathode exhaust may be oxidized in the ATO 130. The oxidized cathode exhaust (i.e., ATO exhaust, which is also referred to as system exhaust) flows from the ATO 130 to the cathode recuperator 120, through cathode exhaust conduit 304B. Exhaust flows from the cathode recuperator 120 and out of the hotbox 50 through at least one exhaust outlet conduit, such as exhaust outlet conduits 304C and/or 304D. In one embodiment, the power module 100 may include two exhaust outlet conduits 304C, 304D in order to output the system exhaust (which may also be referred to as cathode exhaust or ATO exhaust) from the hotbox 50 rather than a single larger outlet conduit, due to system size constraints. However, the present disclosure is not limited to any particular number of outlet conduits, and a single outlet conduit may be used instead.

The exhaust outlet conduits 304C, 304D may be configured to provide the system exhaust to the exhaust manifold 60. The exhaust manifold 60 may optionally be configured to vent the exhaust to the atmosphere and the thermal energy system 20 may be omitted. In some embodiments, an optional exhaust fan 62 may be located in the exhaust manifold 60 in order to overcome static pressure in the exhaust manifold 60 and/or a pressure drop generated by the optional thermal system 20. Alternatively, the exhaust fan 62 may be located in the vent 61 and/or in the bypass vent 63.

The power module 10 may further include a system controller 125 configured to control various elements of the power module 10. The controller 125 may include a central processing unit configured to execute stored instructions. For example, the controller 125 may be configured to control fuel and/or air flow through the power module 10, according to fuel composition data.

Referring to FIG. 1B, each power module 100 may include fluidly connected conduit assemblies 302, 304 that fluidly connect system components, such as the system air blower (i.e., main air blower) 116, anode exhaust cooler 140, the cathode recuperator 120, the stack 102, and/or the ATO 130 to the exhaust manifold 60. Accordingly, components of the power modules 100 may be affected by downstream pressure in the exhaust manifold 60.

For example, in some embodiments a positive pressure may be generated in the exhaust manifold 60 due to system exhaust flow from the power modules 100 into the exhaust manifold 60 and/or a static pressure within the exhaust manifold 60. A pressure drop generated by the thermal system 20 may also contribute to generating a positive pressure in the exhaust manifold 60.

During steady-state operation of the system 30, one or more of the power modules 100 may be offline, for example for servicing or for an emergency shutdown, and the system air blower 116 of the offline power module 100 may be stopped. As a result, backflow of exhaust from the exhaust manifold 60 into the offline power module 100 may occur. Exhaust backflow may expose the system air blower 116 to temperatures that may exceed the rated temperature thereof. For example, the bearings of the system air blower 116 may be damaged by temperatures that exceed about 130° C. As such, the system air blower 116 may be damaged by exposure to relatively hot system exhaust from the exhaust manifold 60.

According to various embodiments, the power modules 100 may include one or more valves to control system exhaust backflow to prevent such backflow from reaching the system air blower 116. For example, the power module 100 may include a control valve 200, such as an electrically operated gate valve, located on the air conduit 302A between the system air blower 116 and a pressure sensor 340. The control valve 200 may be configured to control exhaust backflow through the air conduit assemblies 302, 304 of the power module 100. For example, the control valve 200 in an offline power module 100 may be closed in order to prevent higher pressure exhaust in the exhaust manifold 60 from backflowing into the offline (i.e., idle) power module 100 and overheating the system air blower 116.

During system startup (e.g., ignition of the anode exhaust in the ATO 130 to begin oxidation of the anode exhaust), the system air blower 116 may be operated to provide air to the ATO 130. However, in some embodiments, the lowest speed of the system air blower 116 and/or suction applied to the air flow path due to the operation of the exhaust fan 62, may result in an air flow rate that exceeds an air flow rate needed to achieve a desired fuel-to-air ratio in the ATO 130. As such, the valve 200 may be partially closed in order to restrict air flow to the ATO 130, such that fuel and air may be provided to the ATO 130 at a ratio sufficient for ATO 130 ignition (e.g., by a glow plug or by a spark plug igniter).

During steady-state operation of the power module 100, the control valve 200 may be completely open so as not to impede air flow from the system air blower 116 to the stack 102.

If the optional exhaust fan 62 is included in the system 30, the exhaust fan 62 may be operated to increase the flow rate of the system exhaust through the exhaust manifold 60. In particular, the exhaust fan 62 may provide a negative pressure in the exhaust manifold 60. During steady-state operation, the power modules 100 may not be affected by the negative exhaust pressure in the exhaust manifold 60. In particular, the pressure in the conduit assemblies 302, 304 of the power modules 100 may exceed the exhaust pressure in the exhaust manifold 60, due to the operation of the system air blowers 116.

However, if at least one of the power modules 100 is taken offline while the remaining power modules 100 of the same system 30 continue to operate, the relatively low pressure in the exhaust manifold 60 may result in a negative pressure (e.g., suction) being applied to the conduit assemblies 302, 304 of the offline power module 100. The suction may beneficially prevent exhaust backflow to the offline power module. However, when the offline power module 100 is subsequently restarted, the suction may increase air flow through the ATO 130 of this power module 100, which may result in an improper fuel-to-air ratio in the ATO 130. As a result, downstream suction may prevent and/or impede ignition of the ATO 130 during attempted restart of the offline power module 100.

In such embodiments, the valve 200 may be operated to reduce air flow through the ATO 130, by restricting air flow through the air conduit assembly 302. For example, the valve 200 may be partially closed, in order to provide an air flow rate through the ATO 130 that provides a fuel-to-air ratio that is within an acceptable range for ignition of the ATO 130.

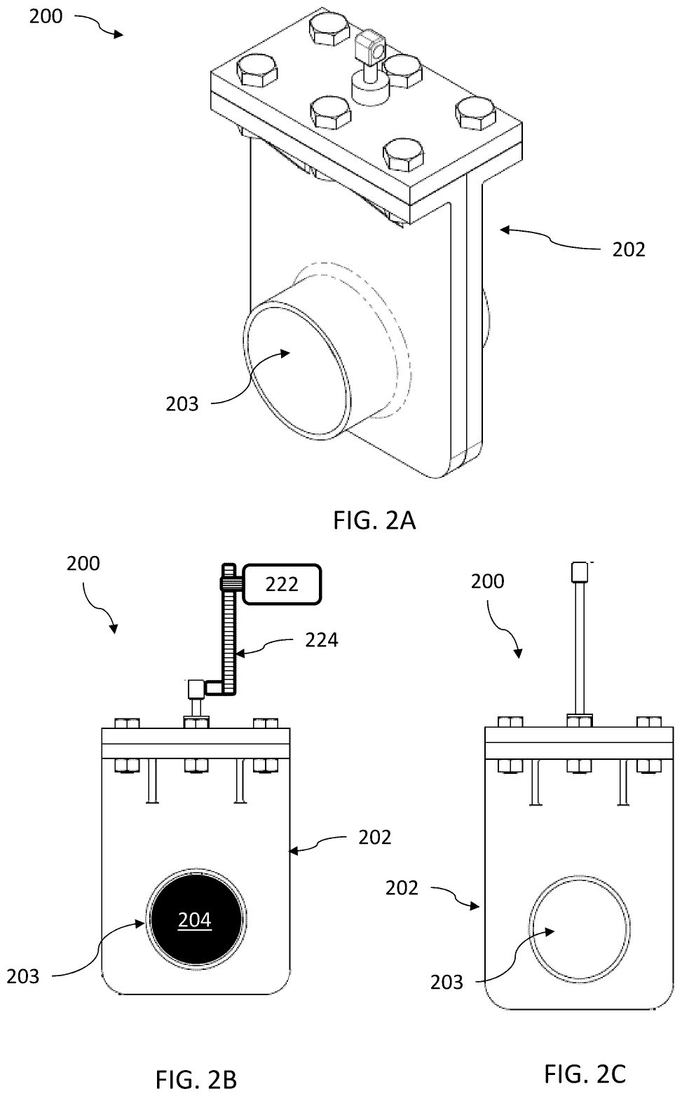

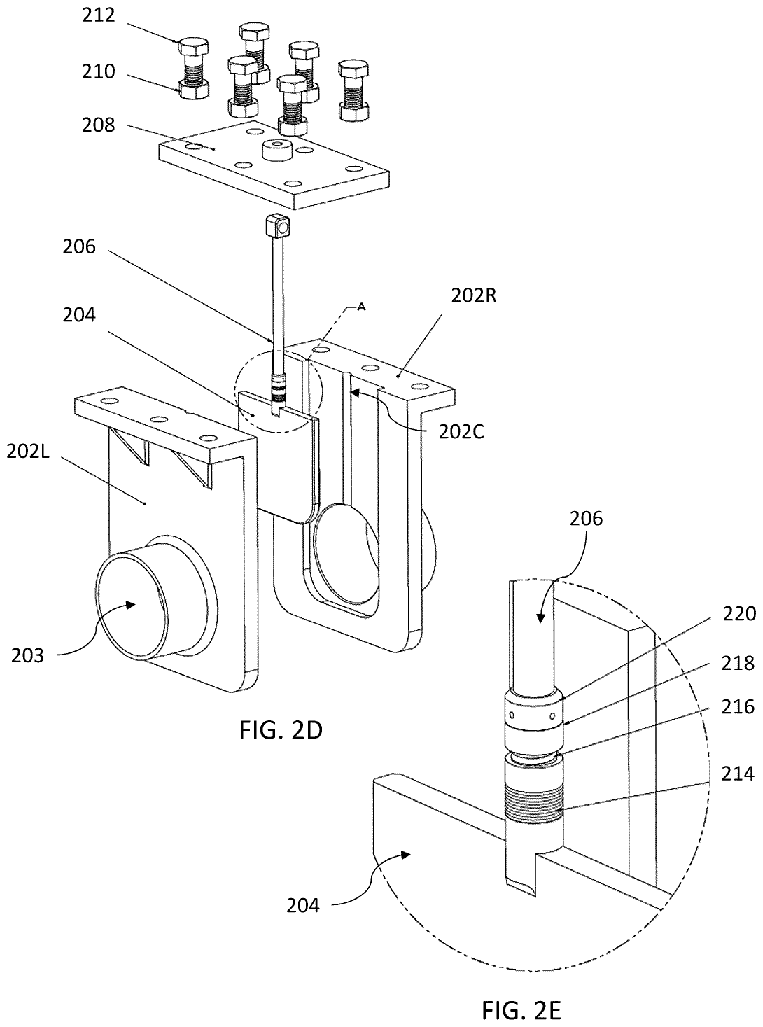

FIG. 2A is perspective view of an exemplary control valve 200 that may be included in the power module of FIG. 1B, according to various embodiments of the present disclosure, FIG. 2B is a plan view showing the valve 200 in a closed position, FIG. 2C is a plan view showing the valve 200 in an open position, FIG. 2D is an exploded perspective view of the valve 200, and FIG. 2E shows an enlarged portion of area “A” in FIG. 2D.

Referring to FIGS. 1B and 2A-2E, space requirements inside of the power module cabinet 40 may make the inclusion of additional components, such as an electrically actuated proportional valve, a challenge. In particular, the present inventors determined that commercially available electrically activated valves are bulky and difficult to fit within the power module cabinet 40.

Therefore, in one embodiment, the control valve 200 comprises a compact gate valve 200. The gate valve 200 is designed to fit within the space available in the power module cabinet 40. In particular, the gate valve 200 may include a valve body 202, a gate 204, a stem 206, and a top plate 208. The valve body 202 may be configured to mate with the air conduit 302A and may include a left plate 202L and a right plate 202R, as shown in FIG. 2D. The left and right plates 202L, 202R may be connected to one another and to the top plate 208 to form the valve body 202. In particular, as shown in FIG. 2D the left and right plates 202L, 202R and the top plate 208 may be connected by fasteners, such as by nuts 210 and bolts 212, or may be welded together.

The gate 204 and the stem 206 may be inserted between the left and right plates 202L, 202R of the valve body 202, and the stem 206 may extend through an opening formed in the top plate 208. In particular, the stem 206 may be connected to an actuator such as an electric motor 222 by a mechanical linkage 224, such as a rack. Operating the motor 222 moves the stem 206 in a vertical direction, such that the gate 204 moves between a closed position, where the gate 204 blocks an opening 203 extending through the left and right plates 202L, 202R of valve body 202 as shown in FIG. 2B, and an open position where the gate 204 does not block the opening 203 as shown in FIG. 2C.

In one embodiment shown in FIG. 2E, the gate 204 may be connected to the stem 206 by lower seal rings 214, a capped spring 216, an upper seal ring 218, and a retaining ring 220. The seal rings may comprise polytetrafluoroethylene or other polymer rings. The seal rings 214, 218 may operate to seal the stem in a channel 202C of the valve body 202. In particular, in the open position, contact between the top plate 208 and the retaining ring 220 may compress the capped spring 216, which may compress the seal rings 214, 218 to provide a gas-tight seal.

Accordingly, the gate valve 200 may be actuated by a motor 222 that is not located on the valve body 202, which reduces the space requirements of the gate valve 200. In addition, the motor 222 may be located distal from high temperature regions in the cabinet 40 and is also protected from high temperature exposure if the valve body 202 is exposed to backfilled exhaust (e.g., system exhaust).

In various embodiments, the controller 125 (see FIG. 1B) may be configured to control the operation of the control valve 200 based on a pressure detected by the pressure sensor (e.g., pressure transducer) 340 and/or an operating mode of the power module 100. For example, the controller 125 may be configured to close the control valve 200 during or after power module 100 shutdown and/or if a pressure detected by the pressure sensor 340 is outside a predetermined pressure range or limit, in order to prevent exhaust backflow to the system air blower 116. The controller 125 may also be configured to partially close the control valve 200 during power module 100 startup, in order to reduce air flow to the ATO 130. For example, the controller 125 may be configured to partially close the control valve 200 if a pressure detected by the pressure sensor 340 is less than a set pressure during ignition of the ATO 130.

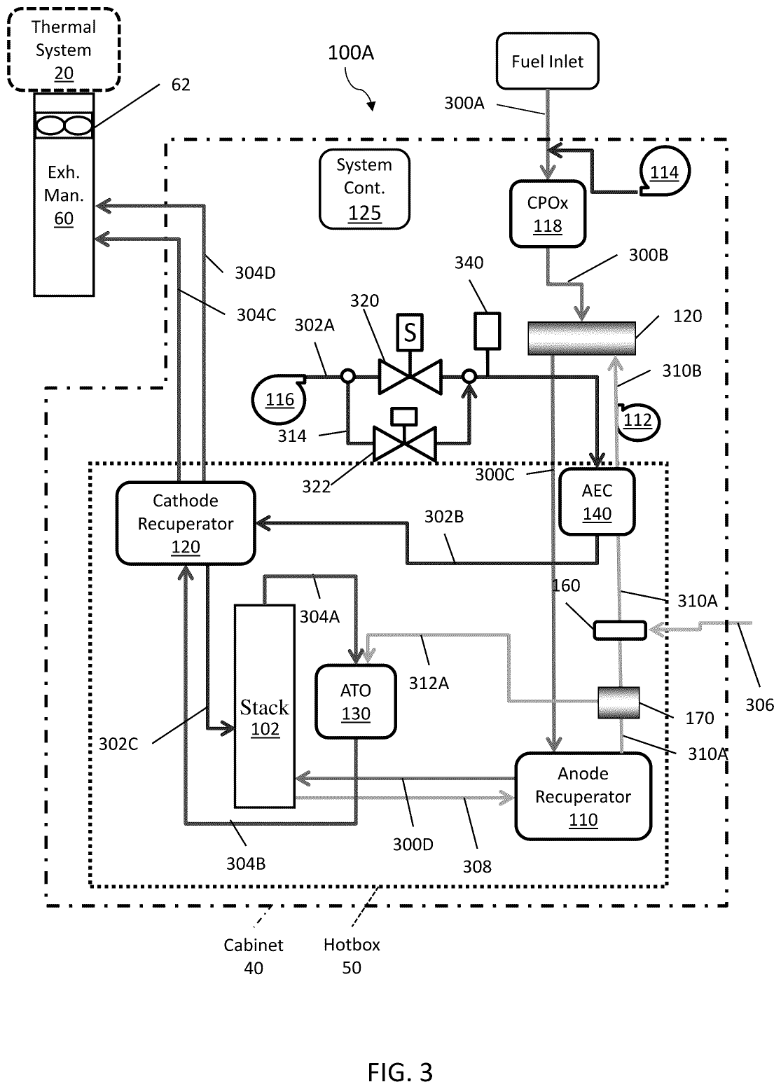

FIG. 3 is a schematic view of an alternative power module 100A, according to an alternative embodiment of the present disclosure. The power module 100A may be similar to the power module 100. As such, only the differences therebetween will be discussed in detail.

Referring to FIG. 3, the control valve of the power module 100A may comprise a gas solenoid valve (GSV) 320 instead of the gate valve 200 shown in FIG. 1B. The GSV is also located on the air conduit 302A between the system air blower 116 and the pressure sensor 340. However, the GSV 320 may not have sufficient air flow rate control at lower air flow rates during power module 100 startup (e.g., during ATO 130 ignition). For example, a GSV designed to handle a maximum flow rate of about 6000 standard liters per minute (SLM) may not be capable of adequately controlling flow rates of less than about 1000 SLM, due to the structure of the GSV.

Thus, in one embodiment, the power module 100A may also optionally include a bypass conduit 314 that bypasses the GSV 320, and a bypass valve 322 located on the bypass conduit 314. The two ends of the bypass conduit 314 are connected to the air conduit 302A upstream and downstream of the GSV 320. In one embodiment, the bypass conduit 314 may have a smaller diameter than the air conduit 302A. The bypass valve 322 may comprise any electrically actuated valve, such as a gate valve or a proportional valve, that is suitable for precise control of low air flow rates (e.g., 0 to 700 SLM). Accordingly, the bypass conduit 314 and the bypass valve 322 may be configured to precisely control low air flow rates provided to the power module 100A during ATO 130 ignition and/or system startup.

During power module 100A startup, the GSV 320 may be opened and the bypass valve 322 may be closed, in order to provide an air flow rate sufficient to purge the ATO 130. Once the ATO purge sequence is complete, the GSV 320 may be closed and the bypass valve 322 may be opened, in order to provide a lower air flow rate to the ATO 130 through the bypass conduit 314 to achieve a desired low air to fuel ratio to ignite the ATO 130. Once the ATO 130 is ignited, the GSV 320 may be opened and the bypass valve 322 may be closed, whereby the power module 100A begins steady-state operation with air flowing through the GSV 320 but not through the bypass conduit 314.

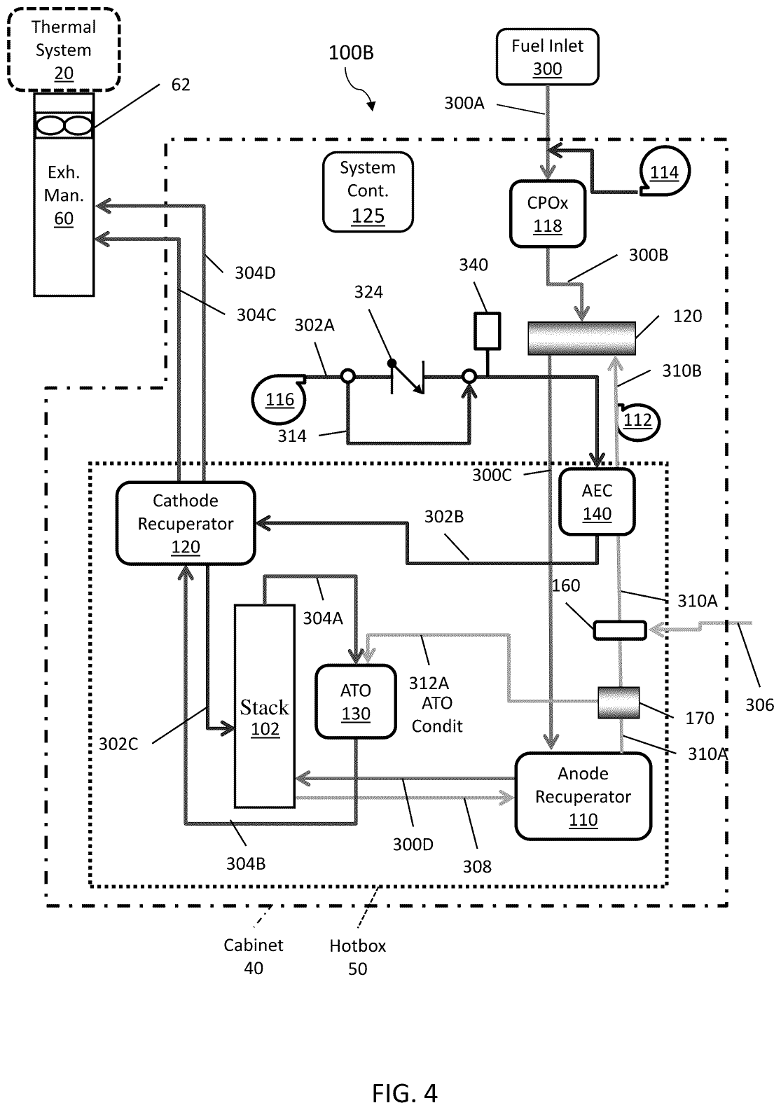

FIG. 4 is a schematic view of an alternative power module 100B, according to another alternative embodiment of the present disclosure. The power module 100B may be similar to the power module 100A. As such, only the differences therebetween will be discussed in detail.

Referring to FIG. 4, the power module 100B may include a nonreturn valve (NRV) 324 instead of the GSV 320. Furthermore, the bypass valve 322 may optionally be omitted in the power module 100B. The bypass conduit 314 has a diameter which is at least 30% smaller, such as 50% to 200% smaller than the diameter of the air conduit 302A.

The NRV 324 may have an opening (e.g., cracking) pressure of about 0.2 to 0.6 psi, such as from about 0.3 to about 0.5 psi, or about 0.4 psi. During steady-state operation of the power module 100B, the system air blower 116 operates at a high speed and generates a pressure higher than the opening pressure of the NRV 324, and a high volume (e.g., at least 1000 slm, such as 2000 to 6000 slm) of air flows through the NRV 324 to the stack 102 for power generation.

However, during system startup, the system air blower 116 may be operated at a lower speed, such that the air flow pressure generated by the system air blower 116 is below the opening pressure of the NRV 324 and is insufficient to open the NRV 324. Therefore, during system startup, the air is provided to the ATO 130 through the bypass conduit 314. In particular, when the system air blower 116 is operated at the lower speed, about 700 slm of air or less, such as about 200 slm of air, may be provided to the ATO 130 during ATO 130 ignition due to the relatively small diameter of the bypass conduit 314.

When the power module 100B is offline (i.e., idle), the system air blower 116 may be stopped and the NRV 324 may automatically close, which prevents exhaust backflow to the system air blower 116 from the exhaust manifold 60. In some embodiments, the relatively small diameter of the bypass conduit 314, in conjunction with the closing of the NRV 324, may be sufficient to protect the system air blower 116 from the system exhaust backflow damage. However, in other embodiments, the optional bypass valve 322 may be located on the bypass conduit to prevent exhaust backflow through the bypass conduit 314.

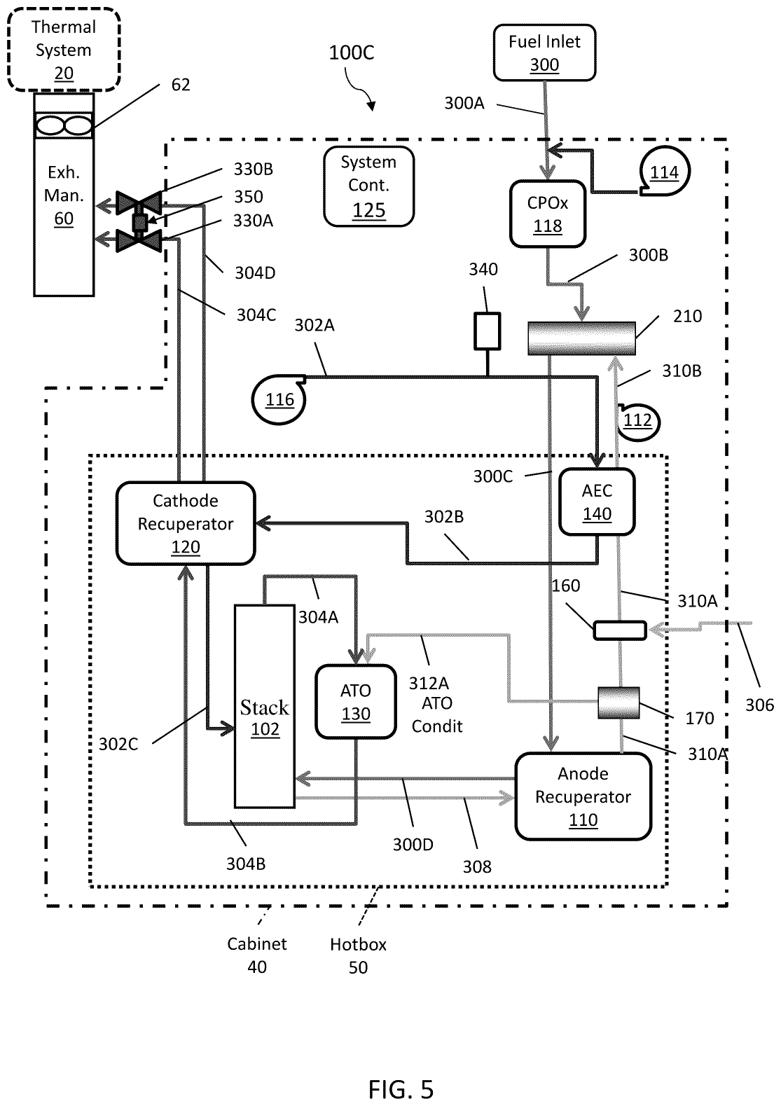

FIG. 5 is a schematic view of an alternative power module 100C, according to another alternative embodiment of the present disclosure. The power module 100C may be similar to the power module 100A. As such, only the differences therebetween will be discussed in detail. The control valve 200, GSV 320 and the NRV 324 on the air conduit 302A may be omitted in the power module 100C. Furthermore, the bypass conduit 314 and the bypass valve 322 may also be omitted in the power module 100C.

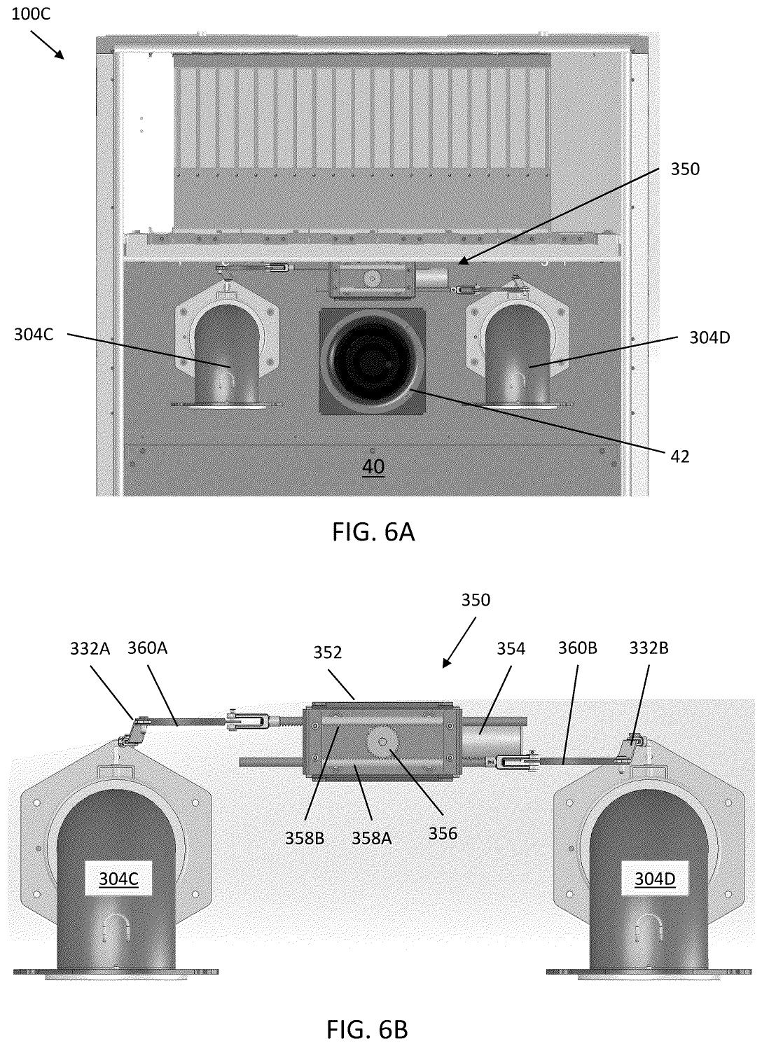

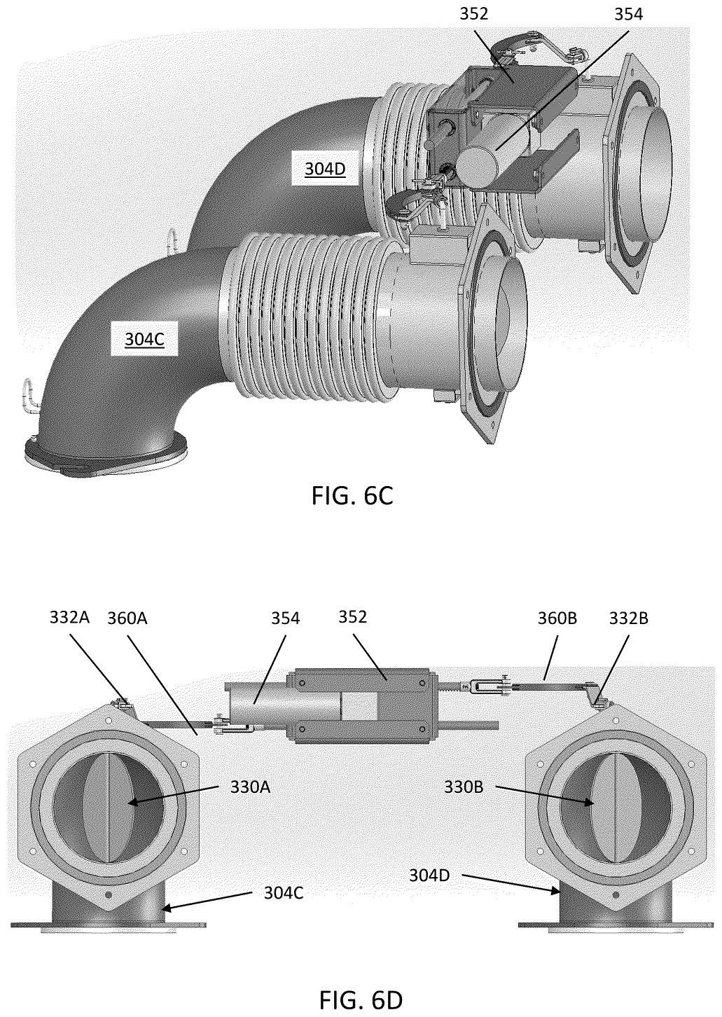

Referring to FIG. 5, the power module 100C may include exhaust valves 330A, 330B configured to control exhaust flow through the exhaust outlet conduits 304C and 304D. The exhaust valves 330A, 330B may be configured to isolate the offline power module 100C from system exhaust flowing through the exhaust manifold 60 from the remaining online power modules 100C in the system 30. In particular, the exhaust valves 330A, 330B may be electrically operated valves, such as butterfly valves. The exhaust valves 330A, 330B control exhaust flow through the exhaust outlet conduits 304C, 304D to prevent backflow of the system exhaust in the exhaust manifold 60 from flowing into the offline power module 100C. For example, the exhaust valves 330A, 330B may be closed when the power module 100C is taken offline (e.g., when its main blower 116 is turned off) to prevent the system exhaust from flowing into the offline power module 100C from the exhaust manifold 60. In one embodiment, both exhaust valves 330A, 330B in the same power module 100C may be operated using the same valve actuator 350, as discussed below with regard to FIGS. 6A-6D.

FIG. 6A shows a portion of the backside of the cabinet 40 of the power module 100C of FIG. 5. A fan 42 may be located in the central compartment on the backside of the cabinet 40. The fan 42 may be configured to pull module cabinet air into a vent from a cabinet exhaust outlet (not shown) of the cabinet 40. The cabinet also includes the valve actuator 350 and exhaust outlet conduits 304C, 304D, according to various embodiments of the present disclosure. FIG. 6B is an enlarged view of the valve actuator 350 and exhaust outlet conduits 304C, 304D, FIG. 6C is a perspective view of the valve actuator 350 and exhaust outlet conduits 304C, 304D, and FIG. 6D is a bottom view of the valve actuator 350 and exhaust outlet conduits 304C, 304D.

Referring to FIGS. 5 and 6A-6D, the valve actuator 350 may be located on the outer surface of the backside of the module cabinet 40 and may be spaced apart from the exhaust outlet conduits 304C, 304D. As such, the valve actuator 350 may be protected from exposure to high temperature system exhaust flowing though the exhaust outlet conduits 304C, 304D.

In one embodiment, the valve actuator 350 may be a rack and pinion type actuator which is configured to open and close two valves using a single motor. As shown in FIG. 6B, the valve actuator 350 may include a housing 352, an electric motor 354, a pinion 356, racks 358A, 358B, and linkages 360A, 360B. The motor 354 may be located in the housing 352 and configured to rotate the pinion 356. In some embodiments, the motor 354 may be a DC brushed motor or the like. The rotation of the pinion 356 drives the simultaneous extension and contraction of the racks 358A, 358B with respect to the housing 352. The linkages 360A, 360B connect the racks 358A, 358B to control arms 332A, 332B of the exhaust valves 330A, 330B.

The exhaust valves 330A, 330B may be closed when the power module 100C is idle, to prevent system exhaust backflow from the exhaust manifold 60 into the hotbox 50. The exhaust valves 330A, 330B may be partially opened during startup of the power module 100C, in order to prevent exhaust suction from interfering with ignition of the ATO 130. In some embodiments, the exhaust valves 330A, 330B may be continuously adjusted during power module 100C startup, in order to maintain a desired fuel-to-air ratio in the ATO 130. The exhaust valves 330A, 330B may be open during steady-state operation of the power module 100C.

Accordingly, the valve actuator 350 may be configured to operate multiple exhaust valves 330A, 330B using a single motor 354 that is not required to withstand high temperatures, which significantly reduces system costs. In addition, the valve actuator 350 synchronizes the opening and closing of multiple exhaust valves 330A, 330B in laterally spaced apart exhaust outlet conduits 304C, 304D using a single point of control. As such, power modules 100C may be individually fluidly disconnected from the exhaust manifold 60 by closing the exhaust valves 330A, 330B while the power module 100C is offline for servicing, emergency shutdown, or the like, while other power modules 100C of the system 30 continue operating to generate power. This reduces system 30 downtime as compared to a total system 30 shutdown.

While the stack 102 is described as being a fuel cell stack, in alternative embodiments, the stack 102 may comprise an electrolyzer cell stack. In the alternative embodiments, the module 100C may comprise an electrolyzer module, and the single motor 354 may simultaneously operate the two exhaust valves of an electrolyzer module.

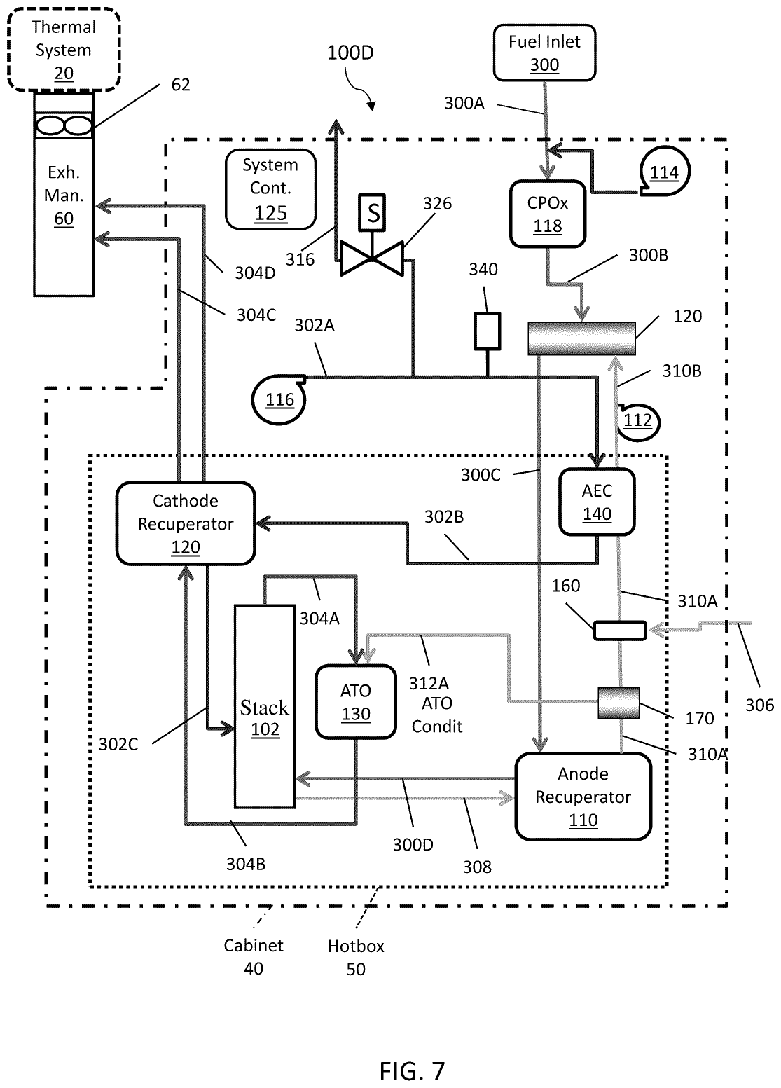

FIG. 7 is a schematic view of an alternative power module 100D, according to an alternative embodiment of the present disclosure. The power module 100D may be similar to the power module 100A. As such, only the differences therebetween will be discussed in detail.

Referring to FIG. 7, the power module 100D may include a vent conduit 316 fluidly connected to the air conduit 302A between the system air blower 116 and the pressure sensor 340. A GSV 326 is located on the vent conduit 316. The GSV 326 may be configured to open the vent conduit 316 in order to prevent exhaust backflow from reaching the system air blower 116. In particular, the GSV 326 may be opened during power module 100D shutdown (e.g., while the power module 100D is offline) such that system exhaust backflow is vented through the vent conduit 316 and the system air blower 116 is protected from excessive temperatures of the system exhaust. The GSV 326 is closed during steady-state operation of the power module 100D.

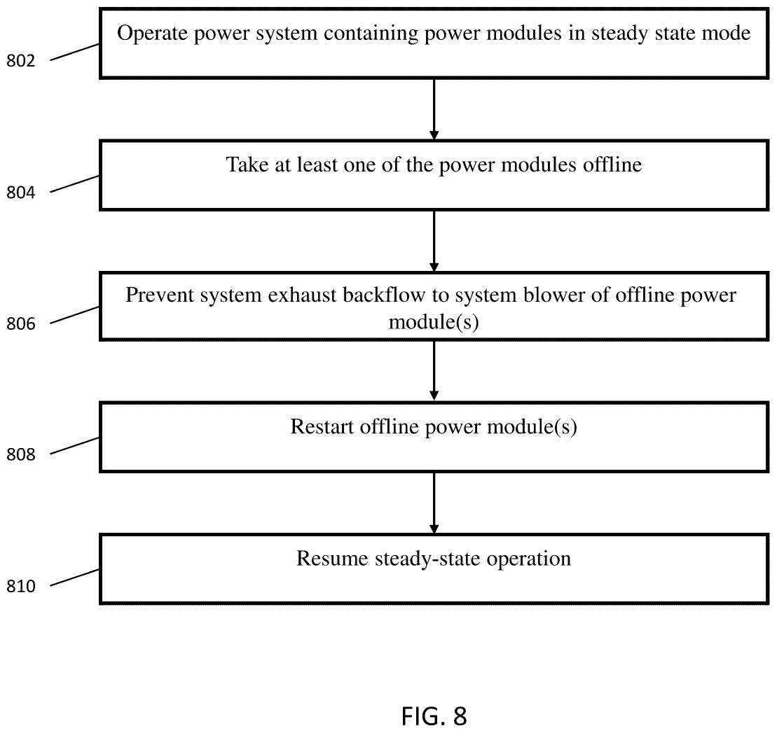

FIG. 8 is a flow chart illustrating steps of a method of operating a fuel cell power system, according to various embodiments of the present disclosure. The method is described with respect to a generic power system, such as a CHP system 30, which may include any of the power modules 100, 100A, 100B, 100C, 100D, disclosed herein.

Referring to FIGS. 1-8, in step 802, the power system containing the power modules is operated in a steady-state mode. In particular, in each power module, fuel may be provided to the stack 102 from the fuel inlet 190, the system air blower 116 of each power module may be operated at a high speed to provide air to the stacks 102, and system exhaust may be output to the exhaust manifold 60.

In step 804 at least one of the power modules of the system may be taken offline (i.e., shut down). In particular, fuel and air flow to the stack 102 may be stopped by stopping the system air blower 116 and by terminating fuel flow from the fuel inlet 190 (e.g., by closing a fuel valve (not shown) on the fuel conduit 300A).

In step 806, system exhaust backflow to the system air blower 116 of the offline power module may be prevented. In particular, system exhaust flow through the air flow path of the offline power module may be prevented by closing the valves 200, 320, 322, and/or 330A and 330B, to prevent the system exhaust flow through the conduit assemblies 302, 304 of the offline power module. In an alternative embodiment, the valve 326 may be opened to divert system exhaust away from the system air blower 116 and into the vent conduit 316.

In step 808, the offline power module(s) may be restarted. In particular, air and fuel may be provided to the ATO 130 of the offline power module, and the ATO 130 may be ignited to heat the power module. The fuel-to-air ratio in the ATO 130 may be controlled by restricting air flow to the ATO 130 through the air flow path. For example, valve 200 may be partially opened, valve 320 or valve 324 may be closed and valve 322 may be partially opened, or valves 330A, 330B may be partially opened, to restrict air flow from the system air blower 116 to the ATO 130 and achieve a desired fuel-to-air ratio in the ATO.

In step 810, steady-state operation of the restarted power module may be resumed. In particular, once the restarted power module reaches its operating temperature, the partially opened valves of step 808 may be completely opened, and valve 326 (if present) may be closed.

Fuel cell systems of the embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A power module, comprising:
a stack of fuel cells;
an anode tail gas oxidizer (ATO) configured to oxidize an anode exhaust output from the stack;
a system air blower configured to provide air to the stack;
at least one air conduit which fluidly connects the system air blower to the stack;
at least one exhaust conduit which fluidly connects the ATO to an exhaust manifold; and
a first valve configured to reduce or prevent backflow of system exhaust from the exhaust manifold to the system air blower when the power module is offline.

2. The power module of claim 1, further comprising a hotbox housing the stack and the ATO, wherein the system air blower is located outside of the hotbox.

3. The power module of claim 2, wherein:
the at least one air conduit comprises a first air conduit that fluidly connects the system air blower to the hotbox; and
the first valve is a gate valve located on the first air conduit.

4. The power module of claim 3, wherein the first valve comprises:
a valve body comprising an opening which extends through the valve body and which is fluidly connected to the first air conduit;
a gate located within the valve body and configured to selectively block all or a portion of the opening; and
an electric motor configured to actuate the gate.

5. The power module of claim 3, further comprising a pressure sensor located on the first air conduit downstream of the first valve with respect to an air flow direction through the first air conduit from the system air blower.

6. The power module of claim 2, wherein:
the at least one air conduit comprises a first air conduit that fluidly connects the system air blower to the hotbox;
the first valve is a gas solenoid valve located on a first air conduit; and
the power module further comprises:
a bypass conduit comprising a first end that is fluidly connected to the first air conduit upstream of the first valve and a second end that is fluidly connected to the first air conduit downstream of the first valve; and
a bypass valve located on the bypass conduit.

7. The power module of claim 2, wherein:
the at least one air conduit comprises a first air conduit that fluidly connects the system air blower to the hotbox; and
the first valve is a nonreturn valve located on a first air conduit.

8. The power module of claim 7, further comprising a bypass conduit comprising a first end that is fluidly connected to the first air conduit upstream of the first valve and a second end that is fluidly connected to the first air conduit downstream of the first valve,
wherein the bypass conduit has a smaller diameter than the first air conduit.

9. The power module of claim 2, wherein:
the at least one air conduit comprises a first air conduit that fluidly connects the system air blower to the hotbox;
the power module further comprises a vent conduit fluidly connected to the first air conduit; and
the first valve is a gas solenoid valve located on the vent conduit.

10. The power module of claim 2, wherein:
the at least one exhaust conduit comprises a first exhaust outlet conduit that fluidly connects the exhaust manifold to the hotbox; and
the first valve comprises an exhaust valve located on the first exhaust outlet conduit.

11. The power module of claim 2, wherein:
the at least one exhaust conduit comprises a first outlet conduit and a second exhaust outlet conduit that fluidly connect the exhaust manifold to the hotbox;
the first valve comprises a first exhaust valve located on the first exhaust outlet conduit; and
the power module further comprises:
a second exhaust valve located on the second exhaust outlet conduit; and
an actuator comprising one motor configured to simultaneously actuate the first and the second exhaust valves.

12. The power module of claim 11, further comprising a rack and pinion assembly which mechanically connects the one motor to the first and the second exhaust valves.

13. The power module of claim 1, further comprising a system controller configured to control the first valve, such that the first valve is closed when the power module is offline to prevent the backflow of system exhaust from the exhaust manifold to the system air blower, such that the first valve is partially closed during ignition of the ATO during restart of the offline power module, and such that the valve is open during a steady-state operation of the power module.

14. A combined heat and power system comprising:
a plurality of the power modules of claim 1; and
a thermal system configured to utilize heat generated by the plurality of the power modules;
wherein the exhaust manifold fluidly connects the exhaust conduits of the plurality of the power modules to the thermal system.

15. An electrochemical module, comprising:
a stack of electrochemical cells located in a hotbox;
a system air blower configured to provide air to the stack;
at least one air conduit which fluidly connects the system air blower to the stack;
first and second exhaust outlet conduits which fluidly connect the hotbox to an exhaust manifold;
a first valve located in the first exhaust outlet conduit and configured to selectively prevent backflow of system exhaust from the exhaust manifold into the hotbox;
a second valve located in the second exhaust outlet conduit and configured to selectively prevent backflow of system exhaust from the exhaust manifold into the hotbox; and
an actuator comprising one motor configured to simultaneously actuate the first and the second valves.

16. The electrochemical module of claim 15, further comprising:
a cabinet housing the hotbox and the system air blower; and
a rack and pinion assembly which mechanically connects the one motor to the first and the second exhaust valves.

17. The electrochemical module of claim 16, wherein:
the actuator is located on an outer surface of the cabinet, between the first and second exhaust outlet conduits; and
the electrochemical cell stack comprises a fuel cell stack.

18. A method of operating a power system comprising a plurality of fuel cell power modules, comprising:
operating the plurality of fuel cell power modules to generate power and output a system exhaust to a common exhaust manifold;
taking one of the plurality of power modules offline; and
actuating at least one valve of the offline fuel cell power module to prevent or reduce system exhaust backflow from the common exhaust manifold to a system air blower of the offline fuel cell power module.

19. The method of claim 18, wherein the at least one valve comprises:
an electrically activated gate valve, a gas solenoid valve or a non-return valve which is closed when the fuel cell power module is taken offline, and which is located in an air conduit that fluidly connects the system air blower to a hotbox of the offline power module; or
two electrically activated proportionate valves which are closed when the fuel cell power module is taken offline, and which are located in exhaust outlet conduits that fluidly connect the hotbox of the offline power module to the exhaust manifold; or
a gate solenoid valve which is opened when the fuel cell power module is taken offline, and which is located in a vent conduit which is fluidly connected to the air conduit.

20. The method of claim 18, further comprising:
restarting the offline fuel cell power module by partially opening the at least one valve, operating the system air blower and igniting an anode tail gas oxidizer (ATO) of the offline fuel cell power module; and
further opening the at least one valve after the ATO is ignited and increasing a speed of the system air blower to operate the restarted fuel cell power module in a steady-state mode.
